(19) United States
(12) Patent Application Publication
(10) Pub. No.: US 2026/0223034 A1
(43) Pub. Date: Jul. 30, 2026

(54) DEVICE AND METHOD OF COMMUNICATION

(71) Applicant: NEC Corporation, Tokyo (JP)

(72) Inventors: Zonghui XIE, Beijing (CN); Gang WANG, Beijing (CN)

(73) Assignee: NEC Corporation, Tokyo (JP)

(21) Appl. No.: 19/146,018

(22) PCT Filed: Jan. 12, 2023
(86) PCT No.: PCT/CN2023/071933

§ 371 Date: Jul. 7, 2025

(51) Int. Cl. H04W 60/04; H04W 60/06

(52) U.S. Cl. CPC H04W 60/04; H04W 60/06

(57) ABSTRACT

Embodiments of the present disclosure relate to devices and methods of communication. In one aspect, a terminal device receives, from an A-IoT device in a set of A-IoT devices, identification information of the A-IoT device; and transmits, to an access network device, the identification information of at least one A-IoT device in the set of A-IoT devices for inventory reporting or registration in a core network. In this way, an inventory and registration procedure for an A-IoT device may be specified.

### TECHNICAL FIELD

Embodiments of the present disclosure generally relate to the field of telecommunication, and in particular, to devices and methods of communication involving an ambient-Internet of things (A-IoT) device.

### BACKGROUND

Recently, it has been proposed to incorporate an A-IoT device into a cellular network communication. However, a solution of cellular communication involving an A-IoT device (also referred to as A-IoT communication herein) is still unclear and needs to be further developed.

### SUMMARY

In general, embodiments of the present disclosure provide methods, devices and computer storage media for A-IoT communication.

In a first aspect, there is provided a terminal device. The terminal device comprises a processor. The processor is configured to cause the terminal device to: receive, from an A-IoT device in a set of A-IoT devices, identification information of the A-IoT device; and transmit, to an access network device, the identification information of at least one A-IoT device in the set of A-IoT devices for inventory reporting or registration in a core network.

In a second aspect, there is provided a terminal device. The terminal device comprises a processor. The processor is configured to cause the terminal device to: determine that a communication with a set of A-IoT devices is to be performed; determine a gap for the communication; and perform the communication based on the gap.

In a third aspect, there is provided an access network device. The access network device comprises a processor. The processor is configured to cause the access network device to: receive, from a terminal device, identification information of at least one A-IoT device in a set of A-IoT devices; and transmit, to a core network device, the identification information for inventory reporting or registration in a core network.

In a fourth aspect, there is provided an access network device. The access network device comprises a processor. The processor is configured to cause the access network device to: determine a gap for a communication with a set of A-IoT devices; and transmit the gap for the communication.

In a fifth aspect, there is provided a core network device. The core network device comprises a processor. The processor is configured to cause the core network device to: receive, from an access network device, identification information of at least one A-IoT device in the set of A-IoT devices for inventory reporting or registration in a core network.

In a sixth aspect, there is provided a method of communication. The method comprises: receiving, at a terminal device and from an A-IoT device in a set of A-IoT devices, identification information of the A-IoT device; and transmitting, to an access network device, the identification information of at least one A-IoT device in the set of A-IoT devices for inventory reporting or registration in a core network.

In a seventh aspect, there is provided a method of communication. The method comprises: determining, at a terminal device, that a communication with a set of A-IoT devices is to be performed; determining a gap for the communication; and performing the communication based on the gap.

In an eighth aspect, there is provided a method of communication. The method comprises: receiving, at an access network device and from a terminal device, identification information of at least one A-IoT device in a set of A-IoT devices; and transmitting, to a core network device, the identification information for inventory reporting or registration in a core network.

In a ninth aspect, there is provided a method of communication. The method comprises: determining, at an access network device, a gap for a communication with a set of A-IoT devices; and transmitting the gap for the communication.

In a tenth aspect, there is provided a method of communication. The method comprises: receiving, at a core network device and from an access network device, identification information of at least one A-IoT device in the set of A-IoT devices for inventory reporting or registration in a core network.

In an eleventh aspect, there is provided a computer readable medium having instructions stored thereon. The instructions, when executed on at least one processor, cause the at least one processor to perform the method according to any of the sixth to tenth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating a process of A-IoT communication according to embodiments of the present disclosure;

FIG. 3 illustrates a schematic diagram illustrating an example process of an inventory reporting according to embodiments of the present disclosure;

FIG. 4 illustrates a schematic diagram illustrating an example process of a registration with a core network according to embodiments of the present disclosure;

FIG. 5 illustrates a schematic diagram illustrating an example process of a registration management according to embodiments of the present disclosure;

FIG. 6 illustrates a schematic diagram illustrating an example process of reporting a failure of an access to an A-IoT device according to embodiments of the present disclosure;

FIG. 7 illustrates a schematic diagram illustrating another process of A-IoT communication according to embodiments of the present disclosure;

FIG. 8 illustrates an example method of communication implemented at a terminal device in accordance with some embodiments of the present disclosure;

FIG. 9 illustrates another example method of communication implemented at a terminal device in accordance with some embodiments of the present disclosure;

FIG. 10 illustrates an example method of communication implemented at an access network device in accordance with some embodiments of the present disclosure;

FIG. 11 illustrates an example method of communication implemented at an access network device in accordance with some embodiments of the present disclosure;

FIG. 12 illustrates an example method of communication implemented at a core network device in accordance with some embodiments of the present disclosure; and

FIG. 13 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space bome vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” may refer to a core network device or an access network device. The term “core network device” refers to any device or entity that provides access and mobility management function (AMF), network exposure function (NEF), authentication server function (AUSF), unified data management (UDM), session management function (SMF), user plane function (UPF), a location management function (LMF), etc. Inother embodiments, the core network device may be any other suitable device or entity providing any other suitable functionality.

As used herein, the term “access network device” refers to a device which is capable of providing or hosting a cell or coverage where terminal devices can communicate. Examples of an access network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “A-IoT” may be interchangeably used with “passive IoT”. The term “A-IoT device” may refer to a device comprising an energy harvesting module and a backscattering module. The A-IoT device may receive an energy supply signal or command via the energy harvesting module and backscatter a signal via the backscattering module. Some example use cases of the A-IoT device are listed below.

| High Level Function | Reference Use Cases | Brief Scenario Description |
|---|---|---|
| Inventory | Automated warehousing | Items are inventoried either at |
| | Airport terminal/shipping port | specific locations or when passing |
| | | through a gate, within a |
| | | warehouse. |
| Object finding | Finding remote lost item | Location of lost item is |
| | Personal belongings finding | determined by UEs/network. |
| Local sensor | Smart home | Reports from one or more sensors |
| reporting | Smart bridge health monitoring | located on a bridge (e.g. tilt, |
| | | vibration, water level) |
| Wide area sensor | Fresh food supply chain | Temperature and/or location |
| reporting | | reports are collected for each item |
| | | e.g. on a regular basis (in a food |
| | | distribution chain i.e. items are not |
| | | stationary) |
| Proximity detection/ | Indoor positioning in shopping | Proximity to a fixed item is used |
| positioning | center | to determine position in an indoor |
| | Museum guide | area. |
| Device state control | Smart agriculture | Network is able to control |
| | | greenhouse conditions in response |
| | | to sensors (e.g. irrigation or |
| | | ventilation) |

In the context of the present disclosure, the term “command UE” may refer to a terminal device transmitting a command to an A-IoT device to implement select, inventory or access (e.g., read and write) to the A-IoT device. The term “excitation UE” may refer to a terminal device providing an excitation signal or energy to an A-IoT device. After receiving the excitation signal, the A-IoT device may generate an induced current, and then receive information and send information through energy obtained by the induced current. It is to be understood that the names “command UE” and “excitation UE” merely are examples, and any other suitable names are also feasible.

Embodiments of the present disclosure provide solutions of cellular communication involving an A-IoT device. In one aspect, a terminal device receives, from a set of A-IoT devices, identification information of each A-IoT device in a set of A-IoT devices, and transmits, to an access network device, the identification information of at least one A-IoT device in the set of A-IoT devices. The access network device transmits, to a core network device, the identification information of the at least one ambient Internet of things (A-IoT) device in the set of A-IoT devices for inventory reporting or registration in a core network (CN). In this way, an A-IoT communication may be achieved.

In another aspect, upon determination that a communication with a set of A-IoT devices is to be performed, a terminal device determines a gap for the communication, and performs the communication based on the gap. In this way, an A-IoT communication may be facilitated.

Principles and implementations of the present disclosure will be described in detail below with reference to the figures.

### Example of Communication Network

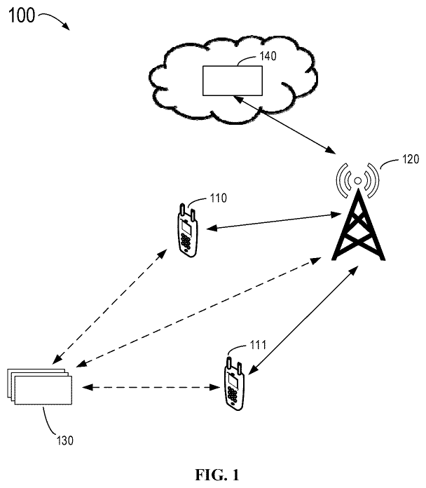

FIG. 1 illustrates a schematic diagram of an example communication network 100 in which some embodiments of the present disclosure can be implemented. As shown in FIG. 1, the communication network 100 may include terminal devices 110 and 111 and an access network device 120. In some embodiments, the access network device 120 may provide one or more serving cells (not shown) to serve the terminal devices 110 and 111.

As shown in FIG. 1, the communication network 100 may further include an A-IoT device 130. In some embodiments, the access network device 120 and the A-IoT device 130 may communicate with each other. In some embodiments, one of the terminal devices 110 and 111 and the A-IoT device 130 may communicate with each other. In some embodiments, the A-IoT device 130 may communicate with one of the terminal devices 110 and 111 in a forward link, and may communicate with the access network device 120 in a backward link. In some embodiments, the A-IoT device 130 may communicate with the access network device 120 in a forward link, and may communicate with one of the terminal devices 110 and 111 in a backward link.

As shown in FIG. 1, the communication network 100 may further include a core network device 140. In some embodiments, the access network device 120 and the core network device 140 may communicate with each other.

It is to be understood that the number of devices in FIG. 1 is given for the purpose of illustration without suggesting any limitations to the present disclosure. The communication network 100 may include any suitable number of access network devices and/or terminal devices and/or A-IoT devices and/or core network devices adapted for implementing implementations of the present disclosure.

The terminal device 110 may communicate with the access network device 120 via a Uu interface. The access network device 120 may communicate with the core network device 140 via an Ng interface. The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some scenarios, the A-IoT device 130 may communicate with an A-IoT server (not shown) via a cellular network comprising the terminal device 110 and/or 111, and the access network device 120 and the core network device 140.

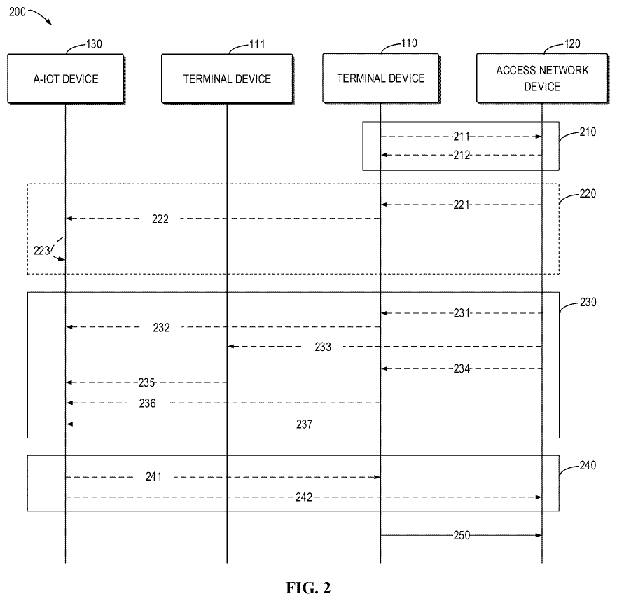

Embodiments of the present disclosure provide solutions of A-IoT communication so as to overcome the above and other potential issues. The detailed description will be made with reference to FIGS. 2 to 6 below.

### Example Implementation of Inventory and Registration Procedure

FIG. 2 illustrates a schematic diagram illustrating a process 200 of communication according to embodiments of the present disclosure. For the purpose of discussion, the process 200 will be described with reference to FIG. 1. The process 200 may involve the terminal devices 110 and 111, the access network device 120 and the A-IoT device 130 as illustrated in FIG. 1. It is to be understood that the steps and the order of the steps in FIG. 2 are merely for illustration, and not for limitation. For example, the order of the steps may be changed. Some of the steps may be omitted or any other suitable additional steps may be added.

As shown in FIG. 2, the terminal device 110 may obtain 210 a configuration for a communication with a set of A-IoT devices. The set of A-IoT devices may be in coverage of the terminal device 110 and needs to be identified. For convenience, the set of A-IoT devices is shown as comprising only one A-IoT device 130 in this example. It is to be understood that more A-IoT devices are also feasible.

In some embodiments, the terminal device 110 may transmit 211, to the access network device 120, a request for obtaining the configuration. For example, the terminal device 110 may transmit the request by indicating that the terminal device 110 is capable of supporting A-IoT communication. The access network device 120 may transmit 212 the configuration to the terminal device 110. In other words, the transmission of the configuration may be considered as a permission of A-IoT communication. Whether to configure A-IoT communication is up to the network side. It is to be understood that the transmission 211 of the request from the terminal device 110 is optional. That is, the access network device 120 may transmit the configuration without the request from the terminal device 110.

In some embodiments, the access network device 120 may transmit, to the terminal device 110, the configuration for A-IoT communication via a radio resource control (RRC) signaling. For example, during a RRC release, the access network device 120 may configure the terminal device 110 to communicate with a set of A-IoT devices after leaving an RRC_CONNECTED state. It is to be understood that any other suitable ways are also feasible for transmission of the configuration, and the present disclosure does not limit this aspect.

In some embodiments, the configuration for A-IoT communication may comprise an indication (i.e., a forward link configuration) indicating whether the communication is triggered by the terminal device 110 or the access network device 120. In some embodiments, the forward link configuration may also indicate a period of the triggering or indicate that the triggering is one-shot.

In some embodiments, the configuration for A-IoT communication may comprise an indication (i.e., a backward link configuration) indicating whether a feedback from the set of A-IoT devices is transmitted to the terminal device 110 or the access network device 120. In some embodiments, the backward link configuration may also indicate a period of an A-IoT report or indicate that the A-IoT report is one-shot. In some embodiments, if the indication indicates the feedback from the set of A-IoT devices is transmitted to the terminal device 110, the terminal device 110 may decide to receive the feedback.

In some embodiments, the configuration for A-IoT communication may comprise a configuration for a report (also referred to as a UE report) for the set of A-IoT devices from the terminal device 110. In some embodiments where the UE report is a periodic report, the configuration for UE report may indicate a period of the UE report. In some embodiments where the UE report is an event-triggered report, the configuration for UE report may indicate an identity of an A-IoT device or the number of A-IoT devices.

In some embodiments, the configuration for A-IoT communication may comprise information of a gap for the communication.

In some embodiments, the configuration for A-IoT communication may comprise a configuration for inventory of the set of A-IoT devices. In some embodiments, the configuration for the inventory may comprise a configuration for a query command (e.g., Query command) transmitted from the terminal device 110 to an A-IoT device in the set of A-IoT devices. For example, the configuration for the query command may comprise at least one of the following:
a link frequency from an A-IoT device to a reader (the terminal device 110 or the network device 120);
a data rate from an A-IoT device to a reader (the terminal device 110 or the network device 120);
an indication indicating whether a pilot is included in a frame header;
an indication indicating which A-IoT devices should response to the command;
an index of a session;
an indication indicating an inventoried flag of A-IoT devices that need to participant an inventory, that is, if an A-IoT device with flag A is indicated, the A-IoT device may change the flag from A to B when the A-IoT device is identified; or
a slot count parameter.

In some embodiments, the configuration for the inventory may comprise a configuration for adjustment of the query command (e.g., QueryAdjust command, can be used to adjust the A-IoT devices response rate). For example, the configuration for adjustment of the query command may comprise at least one of the following: an index of a session; or an indication indicating how to adjust (e.g., increase, remain, or decrease) the slot count parameter.

In some embodiments, the configuration for the inventory may comprise a configuration for repetition of the query command (e.g., QueryRep command, can be used to adjust the slot count parameter). For example, the configuration for repetition of the query command may comprise an index of a session.

In some embodiments, the configuration for the inventory may comprise information of grouping for the set of A-IoT devices, that is, which A-IoT devices need to response. In some embodiments, the information of grouping may comprise at least one of A-IoT device group information or A-IoT device state information.

In some embodiments, the configuration for the inventory may comprise information of a response rate of an A-IoT device in the set of A-IoT devices. In some embodiments, the information of the response rate may comprise at least one of a slot count parameter or a duration of an acknowledgement from a reader (the terminal device 110 or the network device 120).

In some embodiments, the configuration for the inventory may comprise a duration of the inventory. In some embodiments, the configuration for the inventory may comprise information of energy supply for an A-IoT device in the set of A-IoT devices. In some embodiments, the information of energy supply may comprise parameters related to coverage, e.g., operation power, supply range, a period of the energy supply, and/or a duration of the energy supply. It is to be understood that the configuration for the inventory may comprise any combination of the above listed information and any other suitable information.

It is also to be understood that the configuration for A-IoT communication may comprise any combination of the above listed information and any other suitable information. Although the obtaining of the configuration for A-IoT communication is described in connection with the process 200 of FIG. 2, it is to be understood that the configuration for A-IoT communication may also be used in combination with other processes of A-IoT communication.

Continue to refer to FIG. 2, the A-IoT device 130 may receive 220 an energy supply signal and a selection command. In some embodiments, the selection command may comprise the information of grouping for the set of A-IoT devices.

In some embodiments, the access network device 120 may transmit 221 a selection command to the terminal device 110. Upon reception of the selection command, the terminal device 110 may transmit 222 the energy supply signal and the selection command to the A-IoT device 130. In some embodiments, the selection command may be carried by the energy supply signal. In some embodiments, the energy supply signal may be transmitted before transmission of the selection command.

Upon reception the selection command, the A-IoT device 130 may set 223 state information according to the information of grouping for the set of A-IoT devices. In some embodiments, whether to response further A-IoT commands may be determined by comparing the state information of the A-IoT device and the information of grouping indicated in the further A-IoT commands.

It is to be understood that the procedure related to the selection command may be initiated by a network side, and may be a previous procedure of other A-IoT operations. It is also to be understood that this procedure related to the selection command may be optional.

Continue to refer to FIG. 2, the A-IoT device 130 may receive 230 an energy supply signal and an inventory command. In some embodiments, the access network device 120 may transmit 231 an A-IoT command (e.g., inventory command) to the terminal device 110. Upon reception of the A-IoT command, the terminal device 110 may transmit 232 the energy supply signal and the inventory command to the A-IoT device 130 based on the configuration for A-IoT communication. In some embodiments, the inventory command may be carried by the energy supply signal. In some embodiments, the energy supply signal may be transmitted before transmission of the inventory command.

In some alternative embodiments, the access network device 120 may transmit 233, to a further terminal device (e.g., the terminal device 111), an indication indicating energy supply to the A-IoT device 130, and transmit 234 an A-IoT command (e.g., inventory command) to the terminal device 110. Based on the configuration for A-IoT communication obtained in step 210, the terminal device 111 may transmit 235 the energy supply signal to the A-IoT device 130, and the terminal device 110 may transmit 236 the inventory command to the terminal device 110.

In some alternative embodiments, the access network device 120 may transmit 237 the energy supply signal and the inventory command to the A-IoT device 130. In some embodiments, the inventory command may be carried by the energy supply signal. In some embodiments, the energy supply signal may be transmitted before transmission of the inventory command.

Continue to refer to FIG. 2, the A-IoT device 130 may transmit 240 identification information of the A-IoT device 130. In some embodiments, the A-IoT device 130 may transmit 241 the identification information of the A-IoT device 130 to the terminal device 110. In some alternative embodiments, the A-IoT device 130 may transmit 242 the identification information of the A-IoT device 130 to the access network device 120.

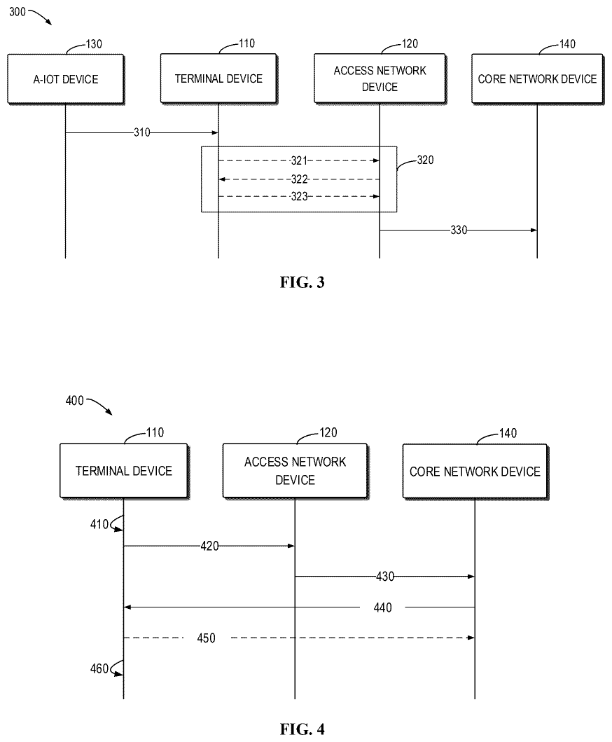

Continue to refer to FIG. 2, upon reception of the identification information of the the A-IoT device 130 (i.e., the set of A-IoT devices), the terminal device 110 may transmit 250, to the access network device 120, the identification information of the set of A-IoT devices for inventory reporting or registration in a core network. More details will be described in connection with FIGS. 3 and 4 below.

In some scenarios, the set of A-IoT devices in the coverage of the terminal device 110 needs to be identified. In this case, an inventory reporting procedure may be initiated. This procedure may be initiated by an A-IoT server or by an upper layer of the terminal device 110. The A-IoT server may be connected to NEF to communicate with core network elements. An inventory command may be transmitted from the A-IoT server to NEF to A-IoT function network element to AMF to RAN. Thus, embodiments of the present disclosure provide a solution of inventory reporting. The solution will be described in connection with FIG. 3.

FIG. 3 illustrates a schematic diagram illustrating an example process 300 of an inventory reporting according to embodiments of the present disclosure. For the purpose of discussion, the process 300 will be described with reference to FIG. 1. The process 300 may involve the terminal device 110, the access network device 120, the A-IoT device 130 and the core network device 140 as illustrated in FIG. 1. It is to be understood that the steps and the order of the steps in FIG. 3 are merely for illustration, and not for limitation. For example, the order of the steps may be changed. Some of the steps may be omitted or any other suitable additional steps may be added.

As shown in FIG. 3, the terminal device 110 may receive 310, from a set of A-IoT devices (e.g., the A-IoT device 130), identification information of the set of A-IoT devices respectively. In other words, the terminal device 110 may obtain identification information of A-IoT devices currently located in coverage of the terminal device 110.

The terminal device 110 may transmit 320 a UE level inventory report to the access network device 120. That is, the terminal device 110 may transmit, to the access network device 120, the identification information of the set of A-IoT devices within the coverage of the terminal device 110. This will assist a radio access network (RAN) to generate a mapping between a set of A-IoT devices and a terminal device.

In the context of the present disclosure, the term “UE level inventory report” may refer to a report including information of A-IoT devices which are located within a terminal device's coverage. The information of A-IoT devices is collected by the terminal device.

In some embodiments, the terminal device 110 may transmit 321, to the access network device 120, an indication indicating availability of the inventory report. In some embodiments, the indication indicating availability of the inventory report may be carried by any suitable RRC messages such as an RRCReconfigurationComplete message, an RRCReestablishmentComplete message, an RRCResumeComplete message, or an RRCSetupComplete message. In some embodiments, the indication indicating availability of the inventory report may be an RRC message itself. For example, upon reception of an RRCConnectionSetup message, an RRCConnectionResume message, an RRCConnectionReestablishment message or an RRCConnectionReconfiguration message, the access network device 120 may consider that the indication indicating availability of the inventory report is received. Alternatively, the indication indicating availability of the inventory report may be carried by UE assistance information (UAI).

In some embodiments, the terminal device 110 may receive 322, from the access network device 120, a request for the inventory reporting, and report 323, as a response to the request, the identification information of the set of A-IoT devices. In some embodiments, the network device 120 may decide to transmit the request for the inventory reporting upon receiving the indication indicating availability of the inventory report. For example, the terminal device 110 may forward the inventory report by a UEInformationResponse message upon reception of a UEInformationRequest message.

Correspondingly, the access network device 120 may obtain identification information of a set of A-IoT devices within coverage of each terminal device served by the access network device 120. The access network device 120 may transmit 330 an RAN level inventory report to the core network device 140. The RAN level inventory report may be forwarded between CN elements, for example, from AMF to A-IoT function network element to NEF and further to an A-IoT server outside the cellular network. In some embodiments, the access network device 120 may generate, based on the UE level inventory report, a mapping between identification information of A-IoT devices and corresponding terminal devices, and forward the mapping to CN. The core network device 140 may use the inventory report to decide how to perform A-IoT communication.

In the context of the present disclosure, the term “RAN level inventory report” may refer to a report including information of A-IoT devices which are located within a target inventory area in an RAN coverage. The information of A-IoT devices is collected by an RAN node.

With the inventory reporting process 300, establishment of a mapping between an A-IoT device and a terminal device at a network side may be facilitated.

In some scenarios, after an A-IoT device is identified, the A-IoT device may need to be registered in CN. Thus, a registration procedure may be initiated. Thus, embodiments of the present disclosure provide a solution of registration. The solution will be described in connection with FIG. 4.

FIG. 4 illustrates a schematic diagram illustrating an example process 400 of a registration with a core network according to embodiments of the present disclosure. For the purpose of discussion, the process 400 will be described with reference to FIG. 1. The process 400 may involve the terminal device 110, the access network device 120 and the core network device 140 as illustrated in FIG. 1. It is to be understood that the steps and the order of the steps in FIG. 4 are merely for illustration, and not for limitation. For example, the order of the steps may be changed. Some of the steps may be omitted or any other suitable additional steps may be added. It is assumed that the terminal device 110 receives identification information of a set of A-IoT devices.

As shown in FIG. 4, the terminal device 110 may determine 410 that at least one A-IoT device (e.g., the A-IoT device 130) in the set of A-IoT devices is inventoried for the first time. In some embodiments, the terminal device 110 may maintain a registered group of A-IoT devices that have been registered to the core network. In some embodiments, the terminal device 110 may store the identification information of A-IoT devices that have been registered to the core network. If identification information of an A-IoT device has not received before, that is, the identification information of the A-IoT device does not belong to the registered group or the identification information of the A-IoT device has not been stored in the terminal device 110, the terminal device 110 may determine that the A-IoT device is inventoried or scanned for the first time.

In this case, the terminal device 110 may establish non-access stratum connections for each of the at least one A-IoT device. The terminal device 110 may initiate a registration procedure to the network side. With reference to FIG. 4, the terminal device 110 may transmit 420, to the access network device 120, a registration request comprising the identification information of the at least one A-IoT device. In some embodiments, upon reception of the registration request from the terminal device 110, the access network device 120 may select a core network device (e.g., AMF) for registration. In some embodiments, the access network device 120 may select the same core network device (e.g., AMF) as that the terminal device 110 registered. In some embodiments, the access network device 120 may select a core network device (e.g., AMF) different from that the terminal device 110 registered. In some embodiments, the terminal device 110 may transmit, to the core network device 140 via the access network device 120, a registration request comprising the identification information of the at least one A-IoT device.

Upon reception of the registration request from the terminal device 110, the access network device 120 may transmit 430, to the core network device 140 (e.g., AMF), a registration request comprising the identification information of the at least one A-IoT device. In some embodiments, the access network device 120 may transmit the registration request to AMF. AMF may communicate with other CN elements (e.g., AUSF and UDM) to perform identification or authentication or security procedure for the at least one A-IoT device.

Then the core network device 140 may transmit 440, to the terminal device 110 via the access network device 120, a response indicating that the registration request is accepted. That is, the core network device 140 accepts the registration request from the terminal device 110. In some embodiments, the terminal device 110 may transmit 450 a message indicating completion of a registration procedure to the core network device 140 via the access network device 120.

With reference to FIG. 4, upon the completion of the registration procedure, the terminal device 110 may add 460 the at least one A-IoT device into the registered group, and set a state of each of the at least one A-IoT device as registered. In some embodiments, the core network device 140 may reject the registration request from the terminal device 110. In this case, the terminal device 110 may set a state of each of the at least one A-IoT device as de-registered.

With the process 400, a terminal device may initiate a registration procedure for A-IoT devices and maintain the registration state of the A-IoT devices.

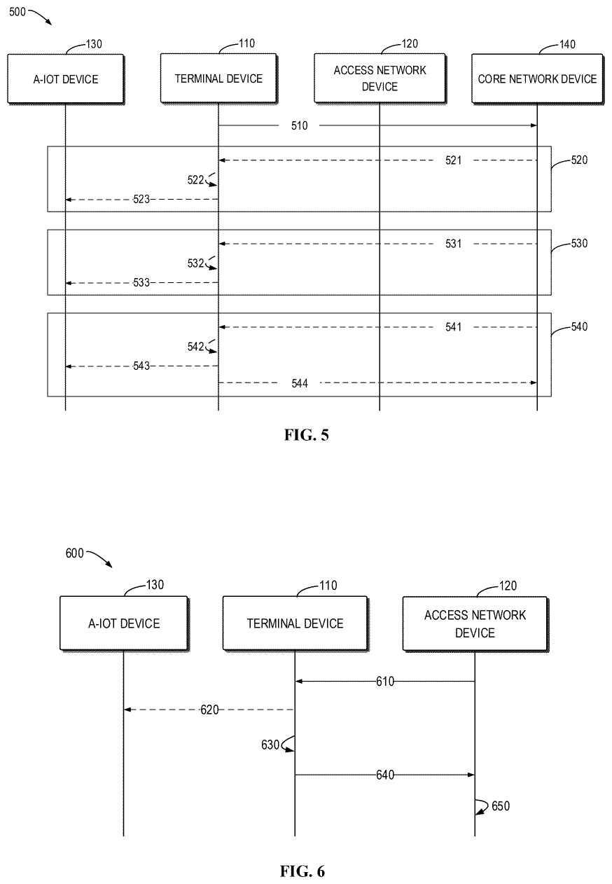

In some scenarios, an A-IoT device needs to register with the network to receive services that requires registration. Once registered and if applicable, the A-IoT device or a terminal device providing an A-IoT command to the A-IoT device may update the A-IoT device's registration with the network. In some embodiments, the A-IoT device's registration may be updated periodically in order to remain reachable (i.e., periodic registration update). In some embodiments, the A-IoT device's registration may be updated upon updating capabilities of the terminal device or re-negotiating protocol parameters (i.e., mobility registration update). Embodiments of the present disclosure provide a solution of registration management. The solution will be described with reference to FIG. 5.

FIG. 5 illustrates a schematic diagram illustrating an example process 500 of a registration management according to embodiments of the present disclosure. For the purpose of discussion, the process 500 will be described with reference to FIG. 1. The process 500 may involve the terminal device 110, the access network device 120, the A-IoT device 130 and the core network device 140 as illustrated in FIG. 1. It is to be understood that the steps and the order of the steps in FIG. 5 are merely for illustration, and not for limitation. For example, the order of the steps may be changed. Some of the steps may be omitted or any other suitable additional steps may be added.

With reference to FIG. 5, the terminal device 110 may transmit 510, to the core network device 140 via the access network device 120, a registration request (or a registration update request) for at least one A-IoT device (e.g., the A-IoT device 130) that is in a de-registered state.

In some embodiments, the core network device 140 may accept 520 the registration request and set a registered state for the A-IoT device 130. In some embodiments, the core network device 140 may transmit 521, to the terminal device 110 via the access network device 120, a response indicating that the registration request is accepted. Based on the response, the terminal device 110 may set 522 a registered state for the A-IoT device 130. Alternatively or additionally, the terminal device 110 may indicate 523 the A-IoT device 130 to enter the registered state.

In some embodiments, the core network device 140 may reject 530 the registration request and remain a de-registered state for the A-IoT device 130. In some embodiments, the core network device 140 may transmit 531, to the terminal device 110 via the access network device 120, a response indicating that the registration request is rejected. Based on the response, the terminal device 110 may remain 532 a de-registered state for the A-IoT device 130. Alternatively or additionally, the terminal device 110 may indicate 533 the A-IoT device 130 to remain the de-registered state.

Continue to refer to FIG. 5, in some embodiments where the A-IoT device 130 is in a registered state, the core network device 140 may initiate 540 a de-registration procedure for the A-IoT device 130. In some embodiments, the core network device 140 may transmit 541, to the terminal device 110 via the access network device 120, a de-registration request for the A-IoT device 130. The terminal device 110 may set 542 a de-registered state for the A-IoT device 130. In some embodiments, the terminal device 110 may indicate 543 the A-IoT device 130 to enter the de-registered state. Upon completion of the de-registration procedure for the A-IoT device 130, the terminal device 110 may transmit 544, to the core network device 140 via the access network device 120, a response indicating that the de-registration request is accepted.

Alternatively or additionally, in some embodiments where the A-IoT device 130 is in a registered state, if a state of the A-IoT device 130 is changed, e.g., if a life cycle of the A-IoT device 130 ends, the terminal device 110 initiates a de-registration procedure for the A-IoT device 130, the terminal device 110 may transmit, to the core network device 140 via the access network device 120, a de-registration request for the A-IoT device 130 and the terminal device 110 may set a de-registered state for the A-IoT device 130. In some embodiments, the terminal device 110 may indicate the A-IoT device 130 to enter the de-registered state.

In some embodiments where a registered request for the A-IoT device 130 is accepted, or upon setting a registered state for the A-IoT device 130, the terminal device 110 may start a timer. The timer may be configured for the terminal device 110 for period registration update. If the timer expires, the terminal device 110 may perform a periodic registration update procedure for the A-IoT device 130. This will notify the network that the A-IoT device 130 is still active. In some embodiments, upon accepting a registered request from the terminal device 110 for the at least one A-IoT device, the core network device 140 may start an Implicit Deregistration timer based on the timer configured for the terminal device 110 for period registration update. In some embodiments, the value of the Implicit Deregistration timer may be longer than the timer configured for the terminal device 110 for period registration update. If the timer expires, the core network device 140 may perform Implicit Deregistration for the at least one A-IoT device. For example, enter a de-registered state for the A-IoT device without sending de-registration request to the terminal device 110.

For illustration, an example UE behavior may be described as below: In a de-registered state of an A-IoT device, the corresponding command UE of the A-IoT device shall:
attempt to register with the selected PLMN using the Initial Registration procedure if the A-IoT device needs to receive service that requires registration; and
maintain the registration state for the A-IoT device: remain the A-IoT device in the de-registered state if receiving a Registration Reject upon Initial Registration; enter registered state upon receiving a Registration Accept.

In a registered state of an A-IoT device, the corresponding command UE of the A-IoT device shall:
perform a Periodic Registration Update procedure triggered by expiration of a periodic update timer to notify the network that the A-IoT device is still active;
perform a Deregistration procedure, and enter de-registered state, when the A-IoT device needs to be no longer registered with the PLMN; and
maintain the registration state for the A-IoT device: enter de-registered state when receiving a Registration Reject message or a Deregistration message.

For illustration, an example AMF behavior may be described as below:

When the A-IoT device's state in the AMF is de-registered, the AMF shall:
when applicable, accept the Initial Registration of an A-IoT device from the UE by sending a Registration Accept to this UE and enter a registered state for the UE; or
when applicable, reject the Initial Registration of an A-IoT device from the UE by sending a Registration Reject to this UE.

When the A-IoT device's state in the AMF is registered, the AMF shall:
perform Deregistration procedure, and enter de-registered state for the A-IoT device, when the A-IoT device needs to be no longer registered with the PLMN. The network may decide to deregister the A-IoT device at any time;
perform Implicit Deregistration at any time after the Implicit Deregistration timer expires. The AMF shall enter a de-registered state for the A-IoT device after Implicit Deregistration;
when applicable, accept or reject Registration Requests for the A-IoT device from the UE; and
maintain the mapping relationship between the command UE and the A-IoT device.

With the process 500, management for registration of an A-IoT device may be achieved.

FIG. 6 illustrates a schematic diagram illustrating an example process 600 of reporting a failure of an access to an A-IoT device according to embodiments of the present disclosure. For the purpose of discussion, the process 600 will be described with reference to FIG. 1. The process 600 may involve the terminal device 110, the access network device 120 and the A-IoT device 130 as illustrated in FIG. 1. It is to be understood that the steps and the order of the steps in FIG. 6 are merely for illustration, and not for limitation. For example, the order of the steps may be changed. Some of the steps may be omitted or any other suitable additional steps may be added.

With reference to FIG. 6, the access network device 120 may transmit 610, to the terminal device 110, a command for accessing to an A-IoT device (e.g., the A-IoT device 130). In some embodiments, the command may comprise identification information of the A-IoT device.

The terminal device 110 may attempt 620 to access the A-IoT device 130. In some embodiments, the A-IoT device 130 may be associated with the terminal device 110, that is, the A-IoT device 130 may belong to a registered group maintained by the terminal device 110 or the identification information of the A-IoT device 130 is stored in the terminal device 110. In this case, the terminal device 110 may attempt to access the A-IoT device 130, but may fail to access the A-IoT device 130. In some embodiments, the terminal device 110 may receive command for the A-IoT device 130 which is not associated with the terminal device 110, that is, the A-IoT device 130 may not belong to a registered group maintained by the terminal device 110 or the identification information of the A-IoT device 130 is not stored in the terminal device 110. In this case, the terminal device 110 may fail to access the A-IoT device 130.

Upon failure of the accessing, the terminal device 110 may determine 630 that the A-IoT device 130 is unreachable. Then the terminal device 110 may transmit 640, to the access network device 120, an indication indicating the failure of the accessing. In some embodiments, the indication may comprise a cause of the failure.

Upon reception of the indication of the failure of the accessing, the access network device 120 may try to reach 650 the A-IoT device 130 through other command UEs. Alternatively, the access network device 120 may initiate another inventory session to determine through which UE the A-IoT device 130 can be reached.

With the process 600, an operation upon failure of accessing an A-IoT device may be specified.

### Example Implementation of Gap for A-IoT Communication

A-IoT communication may last for a period of time, and thus a gap for the A-IoT communication may be needed for a terminal device. In view of this, embodiments of the present disclosure provide a solution of A-IoT communication based on a gap. The solution will be described in connection with FIG. 7.

FIG. 7 illustrates a schematic diagram illustrating another process 700 of A-IoT communication according to embodiments of the present disclosure. For the purpose of discussion, the process 700 will be described with reference to FIG. 1. The process 700 may involve the terminal device 110, the access network device 120 and the A-IoT device 130 as illustrated in FIG. 1. It is to be understood that the steps and the order of the steps in FIG. 7 are merely for illustration, and not for limitation. For example, the order of the steps may be changed. Some of the steps may be omitted or any other suitable additional steps may be added.

With reference to FIG. 7, the terminal device 110 may determine 710 that a communication with a set of A-IoT devices (e.g. the A-IoT device 130) is to be performed. In some embodiments, the terminal device 110 may receive, from the access network device 120, a command for selecting, inventorying or accessing the set of A-IoT devices. In this case, the terminal device 110 may determine that the communication with the set of A-IoT devices is to be performed.

The terminal device 110 may determine 720 a gap for the communication with the set of A-IoT devices. In some embodiments, if a gap (for convenience, also referred to as a first gap herein) available for the communication is configured (e.g., in the configuration for A-IoT communication obtained in step 210 of FIG. 2), the terminal device 110 may activate 721 the first gap for the communication. In some embodiments, the terminal device 110 may activate the first gap via a medium access control control element (MAC CE).

In some embodiments, if no gap available for the communication is configured, the terminal device 110 may transmit 722, to the access network device 120, an indication that the communication is to be started. Based on the indication of start of the communication, the access network device 120 may determine 723 the first gap for the communication, and transmit 724 the first gap to the terminal device 110. During the first gap, only communication between the terminal device 110 and the A-IoT device 130 is performed and no communication between the terminal device 110 and the access network device 120 is performed.

Upon determination of the gap, the terminal device 110 may perform 730 the communication with the set of A-IoT devices (e.g., the set of A-IoT device 130) based on the gap.

In some embodiments, if the communication with the set of A-IoT devices is to be stopped, the terminal device 110 may transmit 740, to the access network device 120, an indication that the communication is to be stopped. In some embodiments, the terminal device 110 may also transmit, to the access network device 120, the identity of the gap which is to be out of use. Based on the indication of stop of the communication, the access network device 120 may determine that the communication between the terminal device 110 and the set of A-IoT devices using the gap is stopped. In that case, the communication between the terminal device 110 and the access network device 120 may be continued (e.g., the detection or transmission or reception between the terminal device and the serving network device may be continued). In some embodiments, the network device 120 and the terminal device 110 may consider that the gap is available for other procedures (e.g., positioning). In some embodiments, the access network device 120 may also configure the gap for the terminal device 110 for other procedures. In some embodiments, the terminal device 110 may initiate the procedure to indicate stop of the communication even if the terminal device 110 did not previously initiate the procedure to indicate start of the communication.

In this way, a terminal device may indicate to the network that the terminal device is going to start or stop A-IoT related communications which requires stopping of detection or transmission or reception with the serving network device. The terminal device may initiate this procedure only after successful AS security activation or valid A-IoT communication configurations has been received. The A-IoT communication configurations may indicate the requirement for the needed gap. If no sufficient gaps have been configured, the terminal device may indicate to the network that the terminal device is going to start or stop A-IoT related communications. Then the network may make a decision of whether to configure a gap for the terminal device.

For illustration, an example procedure may be described as below:

### UE Shall:

1> if and only if upper layers indicate to start performing A-IoT related communications, and the UE requires gaps for these operations while gaps are either not configured or not sufficient:
   2> if preconfigured gaps for A-IoT related communications are configured and the UE considers that at least one of the preconfigured gaps for A-IoT related communications is sufficient when activated:
      3> trigger the lower layers to initiate the gap activation request using UL
MAC CE;
   2> else:
      3> initiate the procedure to indicate start;
NOTE 1: The UE verifies the gap situation only upon receiving the indication from upper layers. If at this point in time sufficient gaps are available, the UE does not initiate the procedure. Unless it receives a new indication from upper layers, the UE is only allowed to further repeat the procedure in the same PCell once per frequency of the target RAT if the provided gaps are insufficient.
NOTE 1a: When indication is received from upper layers for performing A-IoT related communications and there is pre-configured gap configured (not preconfigured gap A-IoT related communications), the UE considers this preconfigured gap to be not sufficient if the gap is not considered to be always activated.

For illustration, another example procedure may be described as below:

### UE Shall:

1> if and only if upper layers indicate to stop performing A-IoT related communications:
   2> if there is no activated preconfigured gap for A-IoT related communications:
      3> initiate the procedure to indicate stop.
   2> else if there is activated preconfigured gap for A-IoT related communications:
      3> trigger the lower layers to deactivate all the activated gap(s) for A-IoT related communications.
NOTE 2: The UE may initiate the procedure to indicate stop even if it did not previously initiate the procedure to indicate start.

With the process 700, collision between transmissions with an A-IoT device and a network may be avoided.

It is to be understood that the above processes 200 to 700 may be carried out separately or in any suitable combination. The present disclosure does not limit this aspect.

### Example Implementation of Methods

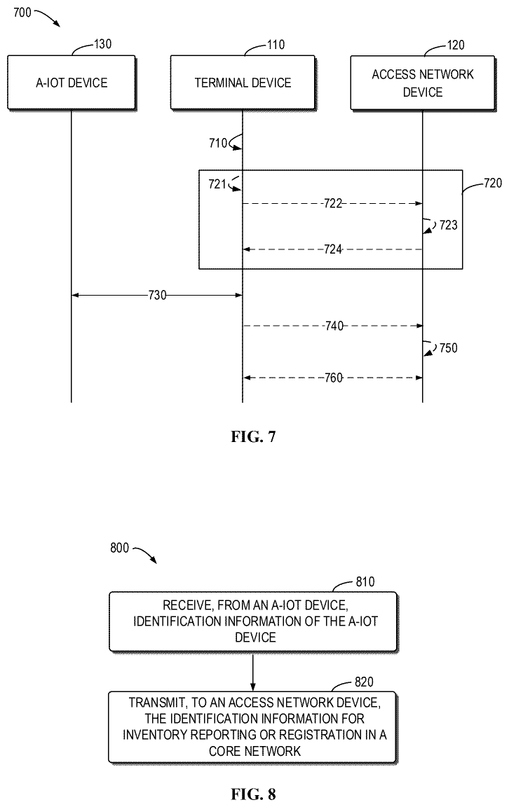

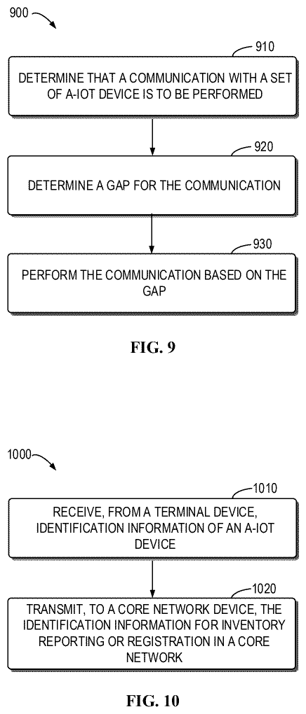

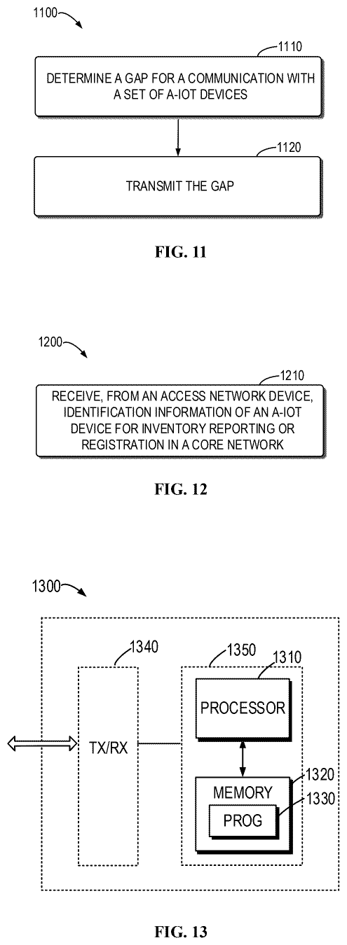

Corresponding to the above processes, embodiments of the present disclosure provide methods of communication implemented at a terminal device and a network device. These methods will be described below with reference to FIGS. 8 to 12.

FIG. 8 illustrates an example method 800 of communication implemented at a terminal device in accordance with some embodiments of the present disclosure. For example, the method 800 may be performed at the terminal device 110 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, the terminal device 110 receives, from an A-IoT device in a set of A-IoT devices, identification information of the A-IoT device.

At block 820, the terminal device 110 transmits, to the access network device 120, the identification information of at least one A-IoT device in the set of A-IoT devices for inventory reporting or registration in a core network.

In some embodiments, the terminal device 110 may transmit, to the access network device 120, a request for obtaining a configuration for a communication with the set of A-IoT devices, and receive the configuration for the communication.

In some embodiments, the configuration may comprise at least one of the following: an indication indicating whether the communication is triggered by the terminal device 110 or the access network device 120; an indication indicating whether a feedback from the set of A-IoT devices is transmitted to the terminal device 110 or the access network device 120; a configuration for a report for the set of A-IoT devices from the terminal device 110; information of a gap for the communication; or a configuration for inventory of the set of A-IoT devices.

In some embodiments, the configuration for the inventory may comprise at least one of the following: a configuration for a query command transmitted from the terminal device to the A-IoT device in the set of A-IoT devices; a configuration for adjustment of the query command; a configuration for repetition of the query command; information of grouping for the set of A-IoT devices; information of a response rate of the A-IoT device in the set of A-IoT devices; a duration of the inventory; or information of energy supply for the A-IoT device in the set of A-IoT devices.

In some embodiments, the terminal device 110 may transmit, based on the configuration, a command indicating the inventory. In some embodiments, the terminal device may transmit the command by transmitting an energy supply signal carrying the command. In some embodiments, the terminal device 110 may transmit an energy supply signal before the transmitting of the command.

In some embodiments, the terminal device 110 may transmit an indication indicating availability of the inventory reporting. In some embodiments, the terminal device 110 may receive a request for the inventory reporting, and report, as a response to the request, the identification information of all A-IoT devices in the set of A-IoT devices.

In some embodiments, if the at least one A-IoT device in the set of A-IoT devices is inventoried for the first time, the terminal device 110 may transmit a registration request comprising the identification information of the at least one A-IoT device.

In some embodiments where the at least one A-IoT device is in a de-registered state, if a registration request for the at least one A-IoT device is rejected, the terminal device 110 may remain the at least one A-IoT device in the de-registered state. If the registration request is accepted, the terminal device 110 may perform at least one of the following: setting a registered state for the at least one A-IoT device; or indicating the at least one A-IoT device to enter the registered state.

In some embodiments where the at least one A-IoT device is in a registered state, if a state of the at least one A-IoT device is changed, or a message indicating de-registration for the at least one A-IoT device is received, or a registration request for the at least one A-IoT device is rejected, the terminal device 110 may perform at least one of the following: setting a de-registered state for the at least one A-IoT device; or indicating the at least one A-IoT device to enter the de-registered state.

In some embodiments, if a registered request for the at least one A-IoT device is accepted, the terminal device 110 may start a timer. If the timer expires, the terminal device 110 may perform a periodic registration update procedure for the at least one A-IoT device.

In some embodiments, the terminal device 110 may receive a command for accessing to the A-IoT device in the set of A-IoT devices. If the A-IoT device is unreachable, the terminal device 110 may transmit an indication indicating a failure of the accessing.

With the method 800, an inventory and/or registration procedure in an A-IoT communication may be specified.

FIG. 9 illustrates another example method 900 of communication implemented at a terminal device in accordance with some embodiments of the present disclosure. For example, the method 900 may be performed at the terminal device 110 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 910, the terminal device 110 determines that a communication with a set of A-IoT devices is to be performed.

At block 920, the terminal device 110 determines a gap for the communication. In some embodiments, if a first gap available for the communication is configured, the terminal device 110 may activate the first gap for the communication. If the first gap available for the communication is not configured, the terminal device 110 may transmit, to an access network device, an indication that the communication is to be started.

At block 930, the terminal device 110 performs the communication based on the gap.

With the method 900, an A-IoT communication may be performed.

FIG. 1000 illustrates an example method 1000 of communication implemented at an access network device in accordance with some embodiments of the present disclosure. For example, the method 1000 may be performed at the access network device 120 as shown in FIG. 1. For the purpose of discussion, in the following, the method 1000 will be described with reference to FIG. 1. It is to be understood that the method 1000 may include additional blocks not shown and/or may omit some blocks as shown, and the scope of the present disclosure is not limited in this regard.

At block 1010, the access network device 120 receives, from the terminal device 110, identification information of at least one A-IoT device in a set of A-IoT devices.

At block 1020, the access network device 120 transmits, to the core network device 140, the identification information for inventory reporting or registration in a core network.

In some embodiments, the access network device 120 may receive a request for obtaining a configuration for a communication with the set of A-IoT devices. In some embodiments, the access network device 120 may transmit the configuration for the communication.

In some embodiments, the configuration may comprise at least one of the following: an indication indicating whether the communication is triggered by the terminal device 110 or the access network device 120; an indication indicating whether a feedback from the set of A-IoT devices is transmitted to the terminal device 110 or the access network device 120; a configuration for a report for the set of A-IoT devices from the terminal device 110; information of a gap for the communication; or a configuration for inventory of the set of A-IoT devices.

In some embodiments, the configuration for the inventory may comprise at least one of the following: a configuration for a query command transmitted from the terminal device to the A-IoT device in the set of A-IoT devices; a configuration for adjustment of the query command; a configuration for repetition of the query command; information of grouping for the set of A-IoT devices; information of a response rate of the A-IoT device in the set of A-IoT devices; a duration of the inventory; or information of energy supply for the A-IoT device in the set of A-IoT devices.

In some embodiments, the access network device 120 may transmit, to the terminal device 110, a command indicating the inventory. In some embodiments, the access network device 120 may transmit, to a further terminal device (e.g., the terminal device 111), a command indicating information of energy supply to the set of A-IoT devices.

In some embodiments, the access network device 120 may transmit, to the set of A-IoT devices, a command indicating the inventory. In some embodiments, the access network device 120 may transmit an energy supply signal to the set of A-IoT devices.

In some embodiments, the access network device 120 may receive an indication indicating availability of the inventory reporting. In some embodiments, the access network device 120 may transmit a request for the inventory reporting, and receive, as a response to the request, the identification information of all A-IoT devices in the set of A-IoT devices.

In some embodiments where the at least one A-IoT device is inventoried for the first time, the access network device 120 may receive a registration request comprising the identification information of the at least one A-IoT device.

In some embodiments, the access network device 120 may transmit, to the terminal device 110, a command for accessing to the A-IoT device in the set of A-IoT devices. In some embodiments, the access network device 120 may receive an indication indicating a failure of the accessing.

With the method 1000, an inventory and/or registration procedure in an A-IoT communication may be facilitated.

FIG. 1100 illustrates another example method 1100 of communication implemented at an access network device in accordance with some embodiments of the present disclosure. For example, the method 1100 may be performed at the access network device 120 as shown in FIG. 1. For the purpose of discussion, in the following, the method 1100 will be described with reference to FIG. 1. It is to be understood that the method 1100 may include additional blocks not shown and/or may omit some blocks as shown, and the scope of the present disclosure is not limited in this regard.

At block 1110, the access network device 120 determines a gap for a communication with a set of A-IoT devices.

In some embodiments, the access network device 120 may receive an indication that the communication is to be started or stopped, and determine the gap for the communication.

At block 1120, the access network device 120 transmits the gap for the communication.

With the method 1100, an A-IoT communication may be facilitated.

FIG. 1200 illustrates an example method 1200 of communication implemented at a core network device in accordance with some embodiments of the present disclosure. For example, the method 1200 may be performed at the core network device 140 as shown in FIG. 1. For the purpose of discussion, in the following, the method 1200 will be described with reference to FIG. 1. It is to be understood that the method 1200 may include additional blocks not shown and/or may omit some blocks as shown, and the scope of the present disclosure is not limited in this regard.

At block 1210, the core network device 140 receives, from the access network device 120, identification information of at least one A-IoT device in the set of A-IoT devices for inventory reporting or registration in a core network.

In some embodiments, the core network device 140 may transmit, to the access network device 120, a command indicating an inventory for the set of A-IoT devices, and receive, from the access network device 120, the identification information of all A-IoT devices in the set of A-IoT devices.

In some embodiments where the at least one A-IoT device is inventoried for the first time, the core network device 140 may receive, from the access network device 120, a registration request comprising the identification information of the at least one A-IoT device.

In some embodiments where the at least one A-IoT device is in a de-registered state, the core network device 140 may accept a registration request for the at least one A-IoT devices, and set a registered state for the at least one A-IoT device.

In some embodiments where the at least one A-IoT device is in a registered state, the core network device 140 may transmit a de-registration request to the terminal device 110, and set a de-registered state for the at least one A-IoT device.

In some embodiments, if a registered request for the at least one A-IoT device is accepted, the core network device 140 may start a timer. If the timer expires, the core network device 140 may set a de-registered state for the at least one A-IoT device.

In some embodiments, the core network device 140 may maintain a mapping between the terminal device and the set of A-IoT devices.

With the method 1200, an inventory and/or registration procedure in an A-IoT communication may be facilitated.

It is to be understood that operations of the methods 800 to 1200 correspond to that described with reference to FIGS. 2 to 7, and thus other details are not repeated here for concise.

### Example Implementation of Device and Apparatus

FIG. 13 is a simplified block diagram of a device 1300 that is suitable for implementing embodiments of the present disclosure. The device 1300 can be considered as a further example implementation of the terminal device 110 or the access network device 120 or the core network device 140 as shown in FIG. 1. Accordingly, the device 1300 can be implemented at or as at least a part of the terminal device 110 or the access network device 120 or the core network device 140.

As shown, the device 1300 includes a processor 1310, a memory 1320 coupled to the processor 1310, a suitable transmitter (TX) and receiver (RX) 1340 coupled to the processor 1310, and a communication interface coupled to the TX/RX 1340. The memory 1310 stores at least a part of a program 1330. The TX/RX 1340 is for bidirectional communications. The TX/RX 1340 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1330 is assumed to include program instructions that, when executed by the associated processor 1310, enable the device 1300 to operate in accordance with the embodiments of the present disclosure, as discussed herein with reference to FIGS. 1 to 12. The embodiments herein may be implemented by computer software executable by the processor 1310 of the device 1300, or by hardware, or by a combination of software and hardware. The processor 1310 may be configured to implement various embodiments of the present disclosure. Furthermore, a combination of the processor 1310 and memory 1320 may form processing means 1350 adapted to implement various embodiments of the present disclosure.

The memory 1320 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1320 is shown in the device 1300, there may be several physically distinct memory modules in the device 1300. The processor 1310 may be of any type suitable to the local technical network, and may include one or more of general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

In some embodiments, a terminal device comprises a circuitry configured to: receive, from an A-IoT device in a set of A-IoT devices, identification information of the A-IoT device; and transmit, to an access network device, the identification information of at least one A-IoT device in the set of A-IoT devices for inventory reporting or registration in a core network.

In some embodiments, a terminal device comprises a circuitry configured to: determine that a communication with a set of A-IoT devices is to be performed; determine a gap for the communication; and perform the communication based on the gap.

In some embodiments, an access network device comprises a circuitry configured to: receive, from a terminal device, identification information of at least one A-IoT device in a set of A-IoT devices; and transmit, to a core network device, the identification information for inventory reporting or registration in a core network.

In some embodiments, an access network device comprises a circuitry configured to: determine a gap for a communication with a set of A-IoT devices; and transmit the gap for the communication.

In some embodiments, a core network device comprises a circuitry configured to: receive, from an access network device, identification information of at least one A-IoT device in the set of A-IoT devices for inventory reporting or registration in a core network.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a terminal device comprises a processor configured to cause the terminal device to: receive, from an ambient Internet of things (A-IoT) device in a set of A-IoT devices, identification information of the A-IoT device; and transmit, to an access network device, the identification information of at least one A-IoT device in the set of A-IoT devices for inventory reporting or registration in a core network.

In some embodiments, the terminal device is further caused to at least one of the following: transmit a request for obtaining a configuration for a communication with the set of A-IoT devices; or receive the configuration for the communication.

In some embodiments, the configuration comprises at least one of the following: an indication indicating whether the communication is triggered by the terminal device or the access network device; an indication indicating whether a feedback from the set of A-IoT devices is transmitted to the terminal device or the access network device; a configuration for a report for the set of A-IoT devices from the terminal device; information of a gap for the communication; or a configuration for inventory of the set of A-IoT devices.

In some embodiments, the configuration for the inventory comprises at least one of the following: a configuration for a query command transmitted from the terminal device to the A-IoT device in the set of A-IoT devices; a configuration for adjustment of the query command; a configuration for repetition of the query command; information of grouping for the set of A-IoT devices; information of a response rate of the A-IoT device in the set of A-IoT devices; a duration of the inventory; or information of energy supply for the A-IoT device in the set of A-IoT devices.

In some embodiments, the terminal device is further caused to: transmit, based on the configuration, a command indicating the inventory.

In some embodiments, the terminal device is caused to transmit the command by transmitting an energy supply signal carrying the command; or wherein the terminal device is further caused to: transmit an energy supply signal before the transmitting of the command.

In some embodiments, the terminal device is caused to transmit the identification information of the at least one A-IoT device by at least one of the following: transmitting an indication indicating availability of the inventory reporting; receiving a request for the inventory reporting; or reporting, as a response to the request, the identification information of all A-IoT devices in the set of A-IoT devices.

In some embodiments, the terminal device is caused to transmit the identification information of the at least one A-IoT device by: in accordance with a determination that the at least one A-IoT device in the set of A-IoT devices is inventoried for the first time, transmitting a registration request comprising the identification information of the at least one A-IoT device.

In some embodiments, the at least one A-IoT device is in a de-registered state, and the terminal device is further caused to: in accordance with a determination that a registration request for the at least one A-IoT device is rejected, remain the at least one A-IoT device in the de-registered state; and in accordance with a determination that the registration request is accepted, perform at least one of the following: setting a registered state for the at least one A-IoT device; or indicating the at least one A-IoT device to enter the registered state.

In some embodiments, the at least one A-IoT device is in a registered state, and the terminal device is further caused to at least one of the following: determine that a state of the at least one A-IoT device is changed, or a message indicating de-registration for the at least one A-IoT device is received, or a registration request for the at least one A-IoT device is rejected; and perform at least one of the following: setting a de-registered state for the at least one A-IoT device; or indicating the at least one A-IoT device to enter the de-registered state.

In some embodiments, the terminal device is further caused to: in accordance with a determination that a registered request for the at least one A-IoT device is accepted, start a timer; and in accordance with a determination that the timer expires, perform a periodic registration update procedure for the at least one A-IoT device.

In some embodiments, the terminal device is further caused to: receive a command for accessing to the A-IoT device in the set of A-IoT devices; and in accordance with a determination that the A-IoT device is unreachable, transmit an indication indicating a failure of the accessing.

In another solution, a terminal device comprises a processor configured to cause the terminal device to: determine that a communication with a set of ambient Internet of things (A-IoT) devices is to be performed; determine a gap for the communication; and perform the communication based on the gap.

In some embodiments, the terminal device is caused to determine the gap by: in accordance with a determination that a first gap available for the communication is configured, activating the first gap for the communication; and in accordance with a determination that the first gap available for the communication is not configured, transmitting, to an access network device, an indication that the communication is to be started.

In another solution, an access network device comprises a processor configured to cause the access network device to: receive, from a terminal device, identification information of at least one ambient Internet of things (A-IoT) device in a set of A-IoT devices; and transmit, to a core network device, the identification information for inventory reporting or registration in a core network.

In some embodiments, the access network device is further caused to at least one of the following: receive a request for obtaining a configuration for a communication with the set of A-IoT devices; or transmit the configuration for the communication.

In some embodiments, the configuration comprises at least one of the following: an indication indicating whether the communication is triggered by the terminal device or the access network device; an indication indicating whether a feedback from the set of A-IoT devices is transmitted to the terminal device or the access network device; a configuration for a report for the set of A-IoT devices from the terminal device; information of a gap for the communication; or a configuration for inventory of the set of A-IoT devices.

In some embodiments, the configuration for the inventory comprises at least one of the following: a configuration for a query command transmitted from the terminal device to the A-IoT device in the set of A-IoT devices; a configuration for adjustment of the query command; a configuration for repetition of the query command; information of grouping for the set of A-IoT devices; information of a response rate of the A-IoT device in the set of A-IoT devices; a duration of the inventory; or information of energy supply for the A-IoT device in the set of A-IoT devices.

In some embodiments, the access network device is further caused to: transmit, to the terminal device, a command indicating the inventory.

In some embodiments, the access network device is further caused to: transmit, to a further terminal device, a command indicating information of energy supply to the set of A-IoT devices.

In some embodiments, the access network device is further caused to at least one of the following: transmit, to the set of A-IoT devices, a command indicating the inventory; or transmit an energy supply signal to the set of A-IoT devices.

In some embodiments, the access network device is caused to receive the identification information of the at least one A-IoT device by at least one of the following: receiving an indication indicating availability of the inventory reporting; transmitting a request for the inventory reporting; or receiving, as a response to the request, the identification information of all A-IoT devices in the set of A-IoT devices.

In some embodiments, the at least one A-IoT device is inventoried for the first time, and the access network device is caused to receive the identification information of the at least one A-IoT device by: receiving a registration request comprising the identification information of the at least one A-IoT device.

In some embodiments, the access network device is further caused to at least one of the following: transmit, to the terminal device, a command for accessing to the A-IoT device in the set of A-IoT devices; or receive an indication indicating a failure of the accessing.

In another solution, an access network device comprises a processor configured to cause the access network device to: determine a gap for a communication with a set of ambient Internet of things (A-IoT) devices; and transmit the gap for the communication.

In some embodiments, the access network device is caused to determine the gap by: receiving an indication that the communication is to be started or stopped; and determining the gap for the communication.

In another solution, a core network device comprises a processor configured to cause the core network device to: receive, from an access network device, identification information of at least one ambient Internet of things (A-IoT) device in the set of A-IoT devices for inventory reporting or registration in a core network.

In some embodiments, the core network device is caused to receive the identification information by: transmitting, to the access network device, a command indicating an inventory for the set of A-IoT devices; and receiving, from the access network device, the identification information of all A-IoT devices in the set of A-IoT devices.

In some embodiments, the at least one A-IoT device is inventoried for the first time, and the core network device is caused to receive the identification information by: receiving, from the access network device, a registration request comprising the identification information of the at least one A-IoT device.

In some embodiments, the at least one A-IoT device is in a de-registered state, and the core network device is further caused to: accept a registration request for the at least one A-IoT devices; and set a registered state for the at least one A-IoT device.

In some embodiments, the at least one A-IoT device is in a registered state, and the core network device is further caused to: transmit a de-registration request to a terminal device; and set a de-registered state for the at least one A-IoT device.

In some embodiments, the core network device is further caused to: in accordance with a determination that a registered request for the at least one A-IoT device is accepted, start a timer; and in accordance with a determination that the timer expires, set a de-registered state for the at least one A-IoT device.

In some embodiments, the core network device is further caused to: maintain a mapping between the terminal device and the set of A-IoT devices.

In another solution, a method of communication comprises: receiving, at a terminal device and from an ambient Internet of things (A-IoT) device in a set of A-IoT devices, identification information of the A-IoT device; and transmitting, to an access network device, the identification information of at least one A-IoT device in the set of A-IoT devices for inventory reporting or registration in a core network.

In another solution, a method of communication comprises: determining, at a terminal device, that a communication with a set of ambient Internet of things (A-IoT) devices is to be performed; determining a gap for the communication; and performing the communication based on the gap.

In another solution, a method of communication comprises: receiving, at an access network device and from a terminal device, identification information of at least one ambient Internet of things (A-IoT) device in a set of A-IoT devices; and transmitting, to a core network device, the identification information for inventory reporting or registration in a core network.

In another solution, a method of communication comprises: determining, at an access network device, a gap for a communication with a set of ambient Internet of things (A-IoT) devices; and transmitting the gap for the communication.

In another solution, a method of communication comprises: receiving, at a core network device and from an access network device, identification information of at least one ambient Internet of things (A-IoT) device in the set of A-IoT devices for inventory reporting or registration in a core network.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 12. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A terminal device comprising:
a processor configured to cause the terminal device to:
receive, from an ambient Internet of things (A-IoT) device in a set of A-IoT devices, identification information of the A-IoT device; and
transmit, to an access network device, the identification information of at least one A-IoT device in the set of A-IoT devices for inventory reporting or registration in a core network.

2. The terminal device of claim 1, wherein the terminal device is further caused to at least one of the following:
transmit a request for obtaining a configuration for a communication with the set of A-IoT devices; or
receive the configuration for the communication.

3. The terminal device of claim 2, wherein the configuration comprises at least one of the following:
an indication indicating whether the communication is triggered by the terminal device or the access network device;
an indication indicating whether a feedback from the set of A-IoT devices is transmitted to the terminal device or the access network device;
a configuration for a report for the set of A-IoT devices from the terminal device;
information of a gap for the communication; or
a configuration for inventory of the set of A-IoT devices.

4. The terminal device of claim 3, wherein the configuration for the inventory comprises at least one of the following:
a configuration for a query command transmitted from the terminal device to the A-IoT device in the set of A-IoT devices;
a configuration for adjustment of the query command;
a configuration for repetition of the query command;
information of grouping for the set of A-IoT devices;
information of a response rate of the A-IoT device in the set of A-IoT devices;
a duration of the inventory; or
information of energy supply for the A-IoT device in the set of A-IoT devices.

5. The terminal device of claim 2, wherein the terminal device is further caused to:
transmit, based on the configuration, a command indicating the inventory.

6. The terminal device of claim 5, wherein the terminal device is caused to transmit the command by transmitting an energy supply signal carrying the command; or
wherein the terminal device is further caused to: transmit an energy supply signal before the transmitting of the command.

7. The terminal device of claim 1, wherein the terminal device is caused to transmit the identification information of the at least one A-IoT device by at least one of the following:
transmitting an indication indicating availability of the inventory reporting;
receiving a request for the inventory reporting; or
reporting, as a response to the request, the identification information of all A-IoT devices in the set of A-IoT devices.

8. The terminal device of claim 1, wherein the terminal device is caused to transmit the identification information of the at least one A-IoT device by:
in accordance with a determination that the at least one A-IoT device in the set of A-IoT devices is inventoried for the first time, transmitting a registration request comprising the identification information of the at least one A-IoT device.

9. The terminal device of claim 1, wherein the at least one A-IoT device is in a de-registered state, and wherein the terminal device is further caused to:
in accordance with a determination that a registration request for the at least one A-IoT device is rejected, remain the at least one A-IoT device in the de-registered state; and
in accordance with a determination that the registration request is accepted, perform at least one of the following:
setting a registered state for the at least one A-IoT device; or
indicating the at least one A-IoT device to enter the registered state.

10. The terminal device of claim 1, wherein the at least one A-IoT device is in a registered state, and wherein the terminal device is further caused to at least one of the following:
determine that a state of the at least one A-IoT device is changed, or a message indicating de-registration for the at least one A-IoT device is received, or a registration request for the at least one A-IoT device is rejected; and
perform at least one of the following:
setting a de-registered state for the at least one A-IoT device; or
indicating the at least one A-IoT device to enter the de-registered state.

11. The terminal device of claim 1, wherein the terminal device is further caused to:
in accordance with a determination that a registered request for the at least one A-IoT device is accepted, start a timer; and
in accordance with a determination that the timer expires, perform a periodic registration update procedure for the at least one A-IoT device.

12. The terminal device of claim 1, wherein the terminal device is further caused to:
receive a command for accessing to the A-IoT device in the set of A-IoT devices; and
in accordance with a determination that the A-IoT device is unreachable, transmit an indication indicating a failure of the accessing.

13. A terminal device comprising:
a processor configured to cause the terminal device to:
determine that a communication with a set of ambient Internet of things (A-IoT) devices is to be performed;
determine a gap for the communication; and
perform the communication based on the gap.

14. The terminal device of claim 13, wherein the terminal device is caused to determine the gap by:
in accordance with a determination that a first gap available for the communication is configured, activating the first gap for the communication; and
in accordance with a determination that the first gap available for the communication is not configured, transmitting, to an access network device, an indication that the communication is to be started.

15. A core network device comprising:
a processor configured to cause the core network device to:
receive, from an access network device, identification information of at least one ambient Internet of things (A-IoT) device in the set of A-IoT devices for inventory reporting or registration in a core network.

16. The core network device of claim 15, wherein the core network device is caused to receive the identification information by:
transmitting, to the access network device, a command indicating an inventory for the set of A-IoT devices; and
receiving, from the access network device, the identification information of all A-IoT devices in the set of A-IoT devices.

17. The core network device of claim 15, wherein the at least one A-IoT device is inventoried for the first time, and wherein the core network device is caused to receive the identification information by:
receiving, from the access network device, a registration request comprising the identification information of the at least one A-IoT device.

18. The core network device of claim 15, wherein the at least one A-IoT device is in a de-registered state, and wherein the core network device is further caused to:
accept a registration request for the at least one A-IoT devices; and
set a registered state for the at least one A-IoT device.

19. The core network device of claim 15, wherein the at least one A-IoT device is in a registered state, and wherein the core network device is further caused to:
transmit a de-registration request to a terminal device; and
set a de-registered state for the at least one A-IoT device.

20. The core network device of claim 15, wherein the core network device is further caused to:
in accordance with a determination that a registered request for the at least one A-IoT device is accepted, start a timer; and
in accordance with a determination that the timer expires, set a de-registered state for the at least one A-IoT device.
